(19) United States
(12) Patent Application Publication
(10) Pub. No.: US 2026/0211355 A1
(43) Pub. Date: Jul. 23, 2026

(54) DEVELOPING CARTRIDGE INCLUDING DEVELOPING ROLLER, HOUSING AND SHAFT COVER THAT INCLUDES HOLE, ARM, AND PROTRUSION

(71) Applicant: BROTHER KOGYO KABUSHIKI KAISHA, Nagoya (JP)

(72) Inventor: Shusaku TSUSAKA, Nagoya (JP)

(73) Assignee: BROTHER KOGYO KABUSHIKI KAISHA, Nagoya (JP)

(21) Appl. No.: 19/451,184

(22) Filed: Jan. 16, 2026

(30) Foreign Application Priority Data
Jan. 23, 2025 (JP) 2025-009552

(51) Int. Cl. G03G 15/08; G03G 21/16

(52) U.S. Cl. CPC G03G 15/0865; G03G 15/0808; G03G 21/1647; G03G 2221/1657

(57) ABSTRACT

A developing cartridge includes: a developing roller; a housing; and a shaft cover. The developing roller includes a shaft extending in an axial direction. The housing includes a first protrusion. The shaft cover covers the shaft. The shaft cover includes an arm and a second protrusion. The arm has a fixed end, a free end and a portion. In the developing cartridge: the free end is positioned further toward the one side in the axial direction than the fixed end; the portion is positioned between the first protrusion and the free end in the axial direction; the portion faces the first protrusion in an opposing direction; the fixed end is positioned apart from the first protrusion in the opposing direction; the second protrusion is positioned apart from the free end in the axial direction; and the second protrusion is engaged with the first protrusion.

### REFERENCE TO RELATED APPLICATIONS

This application claims priority from Japanese Patent Application No. 2025-009552 filed on Jan. 23, 2025. The entire content of the priority application is incorporated herein by reference.

### BACKGROUND ART

A developing cartridge including a developing roller is known. The known developing cartridge includes a gear cover and a collar. The collar is a shaft cover that covers the end portion of a developing roller shaft. The gear cover has an engagement portion for holding the collar. The engagement portion has a hook shape. Since the engagement portion is bent by a jig, the collar can be detached from the gear cover.

### SUMMARY

It is preferable that the shaft cover covering the developing roller shaft is not detached easily, except when the shaft cover is intentionally detached.

In view of the foregoing, it is an object of the present disclosure to provide a shaft cover that is not detached easily from a housing.

In order to attain the above object, the present disclosure provides a developing cartridge including: a developing roller; a housing; and a shaft cover. The developing roller includes a shaft extending in an axial direction. The shaft has one end portion positioned at one side in the axial direction. The housing includes a first protrusion protruding in a direction crossing the axial direction. The shaft cover covers the one end portion of the shaft. The shaft cover has a first hole into which the shaft is fitted. The shaft cover includes an arm and a second protrusion. The arm has a fixed end and a free end. The arm is elastically deformable. The arm further has a portion. The second protrusion protrudes from the arm. In the developing cartridge: the free end is positioned further toward the one side in the axial direction than the fixed end; the portion is positioned between the first protrusion and the free end in the axial direction; the portion faces the first protrusion in an opposing direction; the opposing direction crosses the axial direction; the fixed end is positioned apart from the first protrusion in the opposing direction; the second protrusion is positioned apart from the free end in the axial direction by a predetermined distance; and the second protrusion is engaged with the first protrusion.

In the above structure, the second protrusion of the shaft cover is engaged with the first protrusion of the housing. The fixed end of the arm is positioned apart from the first protrusion in the opposing direction, in which the portion of the arm faces the first protrusion. Hence, upon the shaft cover being moved away from the housing in the axial direction, the portion of the arm is pressed against the first protrusion. As a result, the shaft cover is not detached from the housing easily unless the arm is bent intentionally.

### BRIEF DESCRIPTION OF DRAWINGS

FIG. 1 is a perspective view of a developing cartridge 1.

FIG. 2 is a perspective view of one end portion of the developing cartridge 1 in an axial direction in a state where a shaft cover 4 is detached from the developing cartridge 1.

FIG. 3 is a perspective view of the shaft cover 4.

FIG. 4 is a cross-sectional view of the developing cartridge 1 taken along line IV-IV in FIG. 1.

FIG. 5 is another cross-sectional view of the developing cartridge 1 taken along line IV-IV in FIG. 1 and illustrates a process of attachment of the shaft cover 4 to a shaft 31 of a developing roller 3.

FIG. 6 is another cross-sectional view of the developing cartridge 1 taken along line IV-IV in FIG. 1 and illustrates a state where the shaft cover 4 is being pulled toward one side in the axial direction.

### DESCRIPTION

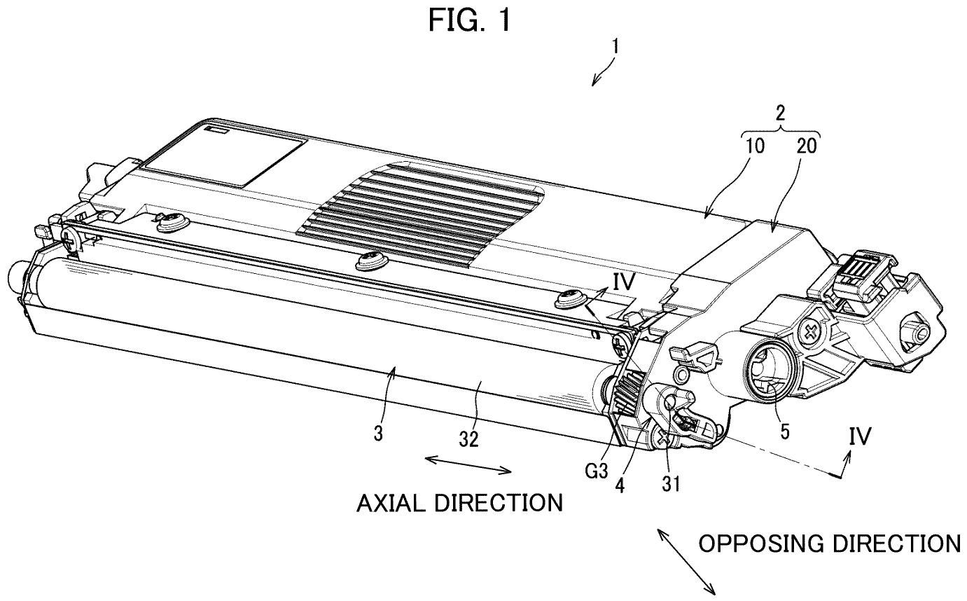

Hereinafter, one embodiment of the present disclosure will be described while referring to the accompanying drawings. As illustrated in FIG. 1, a developing cartridge 1 includes a housing 2, a developing roller 3, a shaft cover 4, and a coupling 5. The developing cartridge 1 is used for an electrophotographic image forming apparatus.

The developing roller 3 includes a shaft 31 and a roller body 32. The shaft 31 extends in an axial direction. The roller body 32 is a rubber layer covering the shaft 31. The shaft 31 has one end portion and the other end portion in the axial direction. The one end portion of the shaft 31 is positioned at one side in the axial direction. The other end portion of the shaft 31 is positioned at the other side in the axial direction. Both the one end portion and the other end portion of the shaft 31 in the axial direction protrude further outward than the housing 2 in the axial direction. Each of the one end portion and the other end portion of the shaft 31 has a columnar shape. The developing roller 3 includes a developing roller gear G3 positioned at the one end portion of the shaft 31 in the axial direction.

The housing 2 includes a toner case 10 and a gear cover 20. The toner case 10 is configured to accommodate toner in the toner case 10. In the axial direction, the toner case 10 has one side surface positioned at the one side in the axial direction and the other side surface positioned at the other side in the axial direction. The gear cover 20 is positioned at the one side surface of the toner case 10 in the axial direction. The gear cover 20 has one side surface and the other side surface in the axial direction. In the axial direction, the one side surface of the gear cover 20 is positioned further toward the one side in the axial direction than the other side surface of the gear cover 20 in the axial direction.

In a state where the shaft cover 4 is attached to the one end portion of the shaft 31 in the axial direction, the shaft cover 4 covers the one end portion of the shaft 31 in the axial direction.

The coupling 5 is rotatably supported by the gear cover 20. The coupling 5 is exposed to the outside of the gear cover 20 from the one side surface of the gear cover 20 in the axial direction. The image forming apparatus is configured to input rotational drive force to the coupling 5.

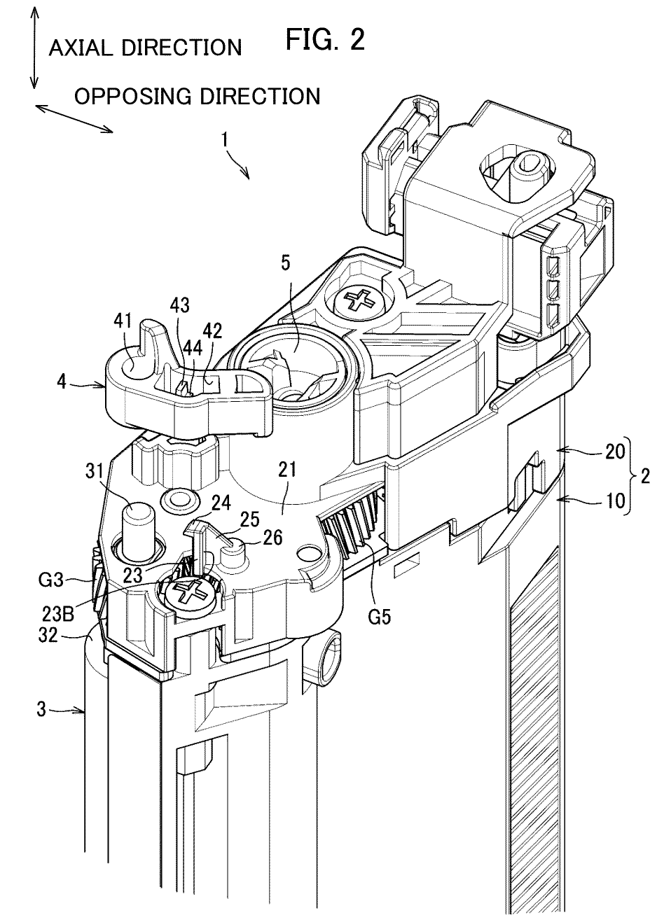

As illustrated in FIG. 2, the coupling 5 includes a coupling gear G5. The coupling 5 and the coupling gear G5 are formed as a single piece. The coupling gear G5 is in meshing engagement with the developing roller gear G3 through one or more gears. The coupling gear G5 may be in meshing engagement with the developing roller gear G3 directly. Each of the developing roller gear G3 and the coupling gear G5 is rotatably supported by both the toner case 10 and the gear cover 20. The gear cover 20 covers both the developing roller gear G3 and the coupling gear G5.

The housing 2 includes a base wall 21, a holding wall 23, a first protrusion 24, a rib 25, and a boss 26. Specifically, the gear cover 20 includes the base wall 21, the holding wall 23, the first protrusion 24, the rib 25, and the boss 26. The gear cover 20 is made of ABS resin, for example.

The base wall 21 is a wall extending in a direction crossing the axial direction. For example, the base wall 21 is orthogonal to the axial direction.

The holding wall 23 protrudes from the base wall 21 toward the one side in the axial direction. In the present embodiment, the upper arrow of the double-headed arrow shown in FIG. 2 is directed toward the one side in the axial direction. The holding wall 23 has a rectangular shape, for example. The holding wall 23 extends linearly in the axial direction.

The first protrusion 24 protrudes from the gear cover 20. Specifically, the first protrusion 24 protrudes from the holding wall 23. The first protrusion 24 protrudes in a direction crossing the axial direction. For example, the first protrusion 24 protrudes in the direction orthogonal to the axial direction. The first protrusion 24 protrudes toward the shaft 31.

The rib 25 extends so as to connect the base wall 21 and the holding wall 23 to each other. The boss 26 protrudes from the base wall 21 toward the one side in the axial direction. The boss 26 is connected to the rib 25. The shaft cover 4 has a hole 41, a second hole 42, an arm 43, and a second protrusion 44.

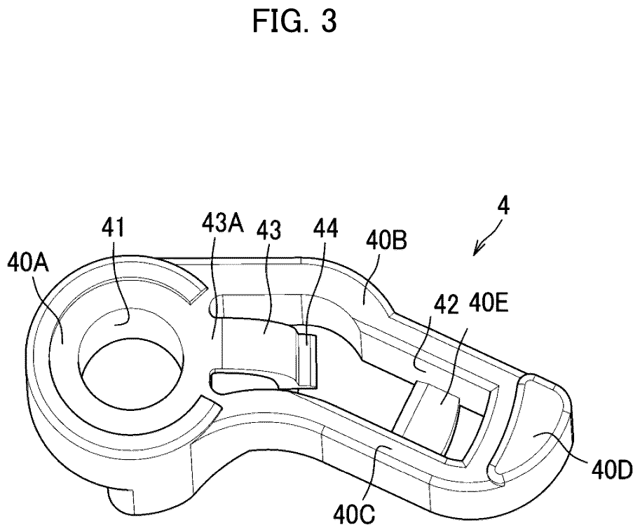

As illustrated in FIG. 3, the shaft cover 4 has a cylindrical portion 40A, a first wall 40B, a second wall 40C, a third wall 40D, and a bridge portion 40E. The cylindrical portion 40A has a cylindrical shape. The hole 41 defined by the inner surface of the cylindrical portion 40A is a hole having a circular cross-section. The one end portion of the shaft 31 in the axial direction is configured to be fitted into the hole 41.T. Both the first wall 40B and the second wall 40C extend from the cylindrical portion 40A in a direction crossing the axial direction. Both the first wall 40B and the second wall 40C are curved. Both the first wall 40B and the second wall 40C extend with a substantially uniform distance between the first wall 40B and the second wall 40C. That is, the first wall 40B and the second wall 40C are spaced apart from each other by the substantially uniform distance. The second hole 42 is a portion (a hole) between the first wall 40B and the second wall 40C. The boss 26 is configured to be fitted into the second hole 42. Accordingly, in a state where the shaft cover 4 is attached to the one end portion of the shaft 31 in the axial direction, the shaft cover 4 is fixed in position by the shaft 31 and the boss 26. The third wall 40D connects the distal end portion of the first wall 40B and the distal end portion of the second wall 40C to each other. The bridge portion 40E connects the first wall 40B and the second wall 40C to each other at a position apart from both the cylindrical portion 40A and the third wall 40D.

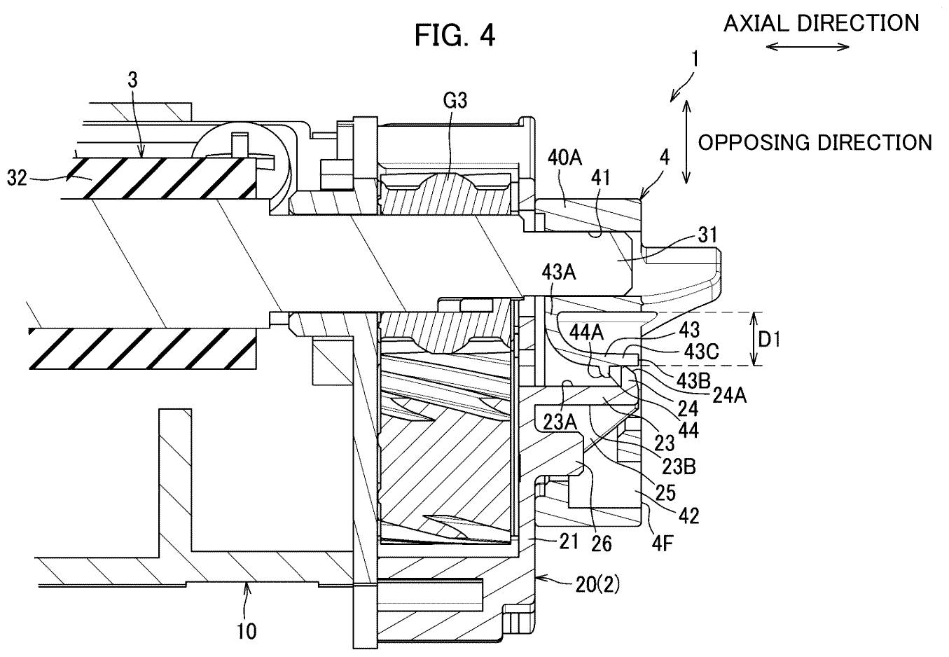

As illustrated in FIG. 4, the arm 43 has a fixed end 43A and a free end 43B. In the axial direction, the free end 43B is positioned further toward the one side in the axial direction than the fixed end 43A. The arm 43 is elastically deformable. The shaft cover 4 is made of POM resin, for example. The elastic modulus of the material of the shaft cover 4 is smaller than the elastic modulus of the material of the first protrusion 24. Hence, the arm 43 is more easily bent than the holding wall 23. In a state where the shaft cover 4 is attached to the one end portion of the shaft 31, the arm 43 is bent, and the portion of the arm 43 is in contact with the first protrusion 24 with the elastic force of the arm 43.

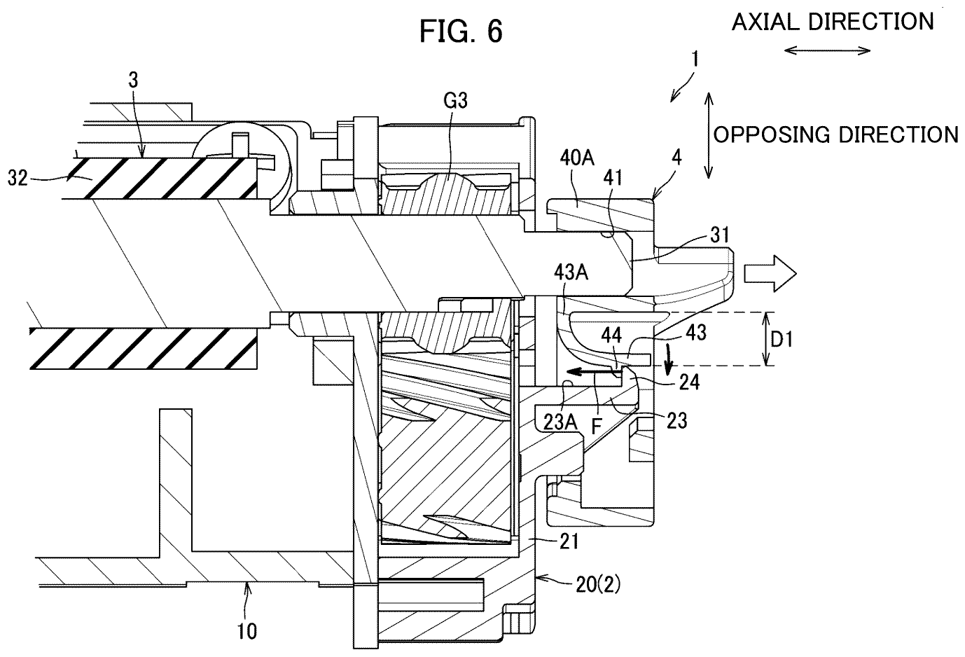

The second protrusion 44 protrudes from the arm 43. The second protrusion 44 is at a position apart from the free end 43B in the axial direction by a predetermined distance. The second protrusion 44 is configured to be engaged with the first protrusion 24. Specifically, as illustrated in FIG. 6, when the shaft cover 4 moves in a direction away from the base wall 21, the second protrusion 44 comes into engagement with the first protrusion 24.

As illustrated in FIG. 4, the arm 43 has a distal end portion 43C. In a state where the shaft cover 4 is attached to the one end portion of the shaft 31, the distal end portion 43C is a portion between the first protrusion 24 and the free end 43B in the axial direction, and the distal end portion 43C faces the first protrusion 24 in an opposing direction crossing the axial direction. In the present embodiment, the opposing direction is a direction connecting the center axis of the shaft 31 and the first protrusion 24 to each other. In the present embodiment, the opposing direction is orthogonal to the axial direction. In a state where the shaft cover 4 is attached to the one end portion of the shaft 31, the fixed end 43A is positioned apart from the first protrusion 24 by a distance D1 in the opposing direction. In the arm 43, the portion of the arm 43 between the fixed end 43A and the second protrusion 44 is curved. Specifically, the portion of the arm 43 between the fixed end 43A and the second protrusion 44 is curved to have a convex shape that bulges toward the base wall 21. The shaft cover 4 has one end surface 4F and the other end surface in the axial direction. In the axial direction, the one end surface 4F of the shaft cover 4 is positioned further toward the one side in the axial direction than the other end surface of the shaft cover 4. In the axial direction, the free end 43B is positioned further toward the other side in the axial direction than the one end surface 4F of the shaft cover 4. In other words, the free end 43B of the arm 43 does not extend further toward the one side in the axial direction than the one end surface 4F.

The first protrusion 24 has one side surface and the other side surface in the axial direction. The one side surface of the first protrusion 24 includes a sloped surface 24A. In the axial direction, the sloped surface 24A is positioned further toward the one side in the axial direction than the other side surface of the first protrusion 24. The sloped surface 24A is sloped relative to the axial direction such that the sloped surface 24A extends (is positioned) toward the other side in the axial direction as the sloped surface 24A extends toward the arm 43. Upon the attachment of the shaft cover 4 to the one end portion of the shaft 31, the second protrusion 44 comes into contact with the sloped surface 24A (the sloped surface 24A may come into contact with the second protrusion 44). Accordingly, the sloped surface 24A facilitates the arm 43 being bent. The second protrusion 44 has one side surface and the other side surface in the axial direction. The other side surface of the second protrusion 44 includes a sloped surface 44A. In the axial direction, the sloped surface 44A is positioned further toward the other side in the axial direction than the one side surface of second protrusion 44. The sloped surface 44A is sloped relative to the axial direction such that the sloped surface 44A extends (is positioned) toward the one side in the axial direction as the sloped surface 44A extends toward the holding wall 23. Upon the attachment of the shaft cover 4 to the one end portion of the shaft 31, the sloped surface 44A comes into contact with the first protrusion 24. Hence, the sloped surface 44A facilitates the arm 43 being bent. The holding wall 23 has a first surface 23A and a second surface 23B. The first surface 23A faces the arm 43. The first protrusion 24 is positioned on the first surface 23A. The second surface 23B is a surface opposite to the first surface 23A. As illustrated in FIG. 2, the rib 25 connects the base wall 21 and the second surface 23B of the holding wall 23 to each other.

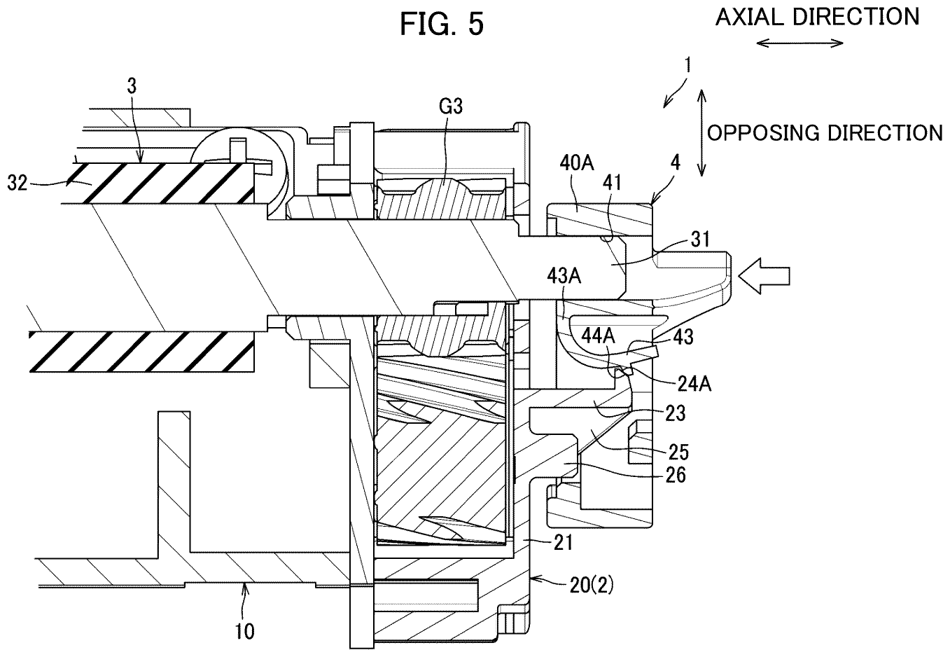

The operations and effects of the developing cartridge 1 described above will be explained. As illustrated in FIG. 5, for attaching the shaft cover 4 to the one end portion of the shaft 31 in the axial direction, the one end portion of the shaft 31 in the axial direction is first inserted into the hole 41. Then, since the shaft cover 4 is pushed toward the housing 2 in the axial direction, the second protrusion 44 of the arm 43 comes into contact with the first protrusion 24. At this time, the sloped surface 44A of the second protrusion 44 contacts the sloped surface 24A of the first protrusion 24, and accordingly the arm 43 is bent toward the shaft 31. Also, the rib 25 connects the base wall 21 and the second surface 23B of the holding wall 23 to each other. As a result, the rigidity of the holding wall 23 is high, and accordingly the first protrusion 24 is less likely to move. On the other hand, since the elastic modulus of the material of the arm 43 is smaller than the elastic modulus of the material of the holding wall 23, the arm 43 is easily bent. Also, bending stress occurs in the arm 43 due to the bending of the arm 43. However, since the portion of the arm 43 from the fixed end 43A to the second protrusion 44 is curved, stress concentration is less likely to occur in the arm 43. Accordingly, the arm 43 has high durability.

When the shaft cover 4 is further pushed toward the housing 2 in the axial direction, the second protrusion 44 of the arm 43 rides over the first protrusion 24 (i.e., the second protrusion 44 of the arm 43 passes over the first protrusion 24). Then, the elastic force of the arm 43 causes the bent arm 43 to return from the bent state. As a result, the second protrusion 44 of the shaft cover 4 comes into engagement with the first protrusion 24. Since the second protrusion 44 is in engagement with the first protrusion 24, the shaft cover 4 is attached to the one end portion of the shaft 31 so as not to be unintentionally detached from the housing 2. As illustrated in FIG. 4, the shaft cover 4 is further pushed toward the other side in the axial direction for contacting the housing 2. In the axial direction, the free end 43B does not extend further toward the one side than the one end surface 4F, which is the one side surface of the shaft cover 4 in the axial direction. Accordingly, the arm 43 is less likely to contact external members, and therefore the likelihood of the arm 43 being bent unintentionally is reduced. Also, in a state where the shaft cover 4 is attached to the one end portion of the shaft 31, the distal end portion 43C of the arm 43 in in contact with the first protrusion 24 by elastic force applied to the arm 43. As a result, the shaft cover 4 is less likely to be unintentionally detached from the one end portion of the shaft 31. Further, in a state where the shaft cover 4 is attached to the one end portion of the shaft 31, the second hole 42 of the shaft cover 4 is fitted on the boss 26. Hence, the shaft cover 4 is fixed in a predetermined orientation with respect to the housing 2.

Although illustration is omitted, for intentionally detaching the shaft cover 4 from the one end portion of the shaft 31, the arm 43 is bent toward the shaft 31 using a jig to disengage the engagement between the second protrusion 44 and the first protrusion 24. As a result, the shaft cover 4 can be detached from the shaft 31 in the axial direction.

As illustrated in FIG. 6, in a case where a user attempts to detach the shaft cover 4 without deforming the arm 43, the second protrusion 44 comes into contact with the first protrusion 24. At this time, a force F is applied to the second protrusion 44 from the first protrusion 24 as illustrated in FIG. 6. As described above, the fixed end 43A of the arm 43 is positioned apart from the first protrusion 24 in the opposing direction. Hence, when the shaft cover 4 is moved away from the housing 2 in the axial direction, a moment acts on the arm 43 by the force F. Then, the distal end portion 43C of the arm 43 is pressed against the first protrusion 24 by the moment. As a result, the shaft cover 4 is not detached from the housing 2 easily unless user intentionally bends the arm 43.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below.

In the above embodiment, the gear cover 20 includes the holding wall 23. However, the toner case 10 may include the holding wall 23. Also, one or more of the other components (for example, a bearing) may include the holding wall 23. The holding wall 23 is positioned at the one side surface of the toner case 10 in the axial direction. However, the holding wall 23 may be positioned at the other side surface of the toner case 10 in the axial direction. In other words, the shaft cover 4 is configured to cover the one end portion of the shaft 31 in axial direction in the above embodiment, however, the shaft cover 4 may be configured to cover the other end portion of the shaft 31 in axial direction. The shaft cover 4 configured to cover the other end portion of the shaft 31 in axial direction may have the same configurations as the configurations of the shaft cover 4 configured to cover the one end portion of the shaft 31 in axial direction in the above embodiment.

The arm 43 is not necessarily in contact with the first protrusion 24 in a state where the shaft cover 4 is attached to the one end portion of the shaft 31. The portion of the arm 43 between the fixed end 43A and the second protrusion 44 may have a straight shape or an L-shape instead of the curved shape described in the above embodiment.

The first protrusion 24 does not necessarily have the sloped surface 24A. The second protrusion 44 does not necessarily have the sloped surface 44A.

In the axial direction, the free end 43B may extend further toward the one side in the axial direction than the one end surface 4F.

The elastic modulus of the material of the shaft cover 4 may be greater than the elastic modulus of the material of the first protrusion 24. The rib 25 may be omitted. The boss 26 may be omitted.

Each element described in the above embodiment and variations may be implemented in any combination.

What is claimed is:

1. A developing cartridge comprising:
a developing roller including a shaft extending in an axial direction, the shaft having one end portion positioned at one side in the axial direction;
a housing including a first protrusion protruding in a direction crossing the axial direction; and
a shaft cover covering the one end portion of the shaft, the shaft cover having a first hole into which the shaft is fitted, the shaft cover including:
an arm having a fixed end and a free end, the arm being elastically deformable, the arm further having a portion; and
a second protrusion protruding from the arm,
wherein,
the free end is positioned further toward the one side in the axial direction than the fixed end,
the portion is positioned between the first protrusion and the free end in the axial direction,
the portion faces the first protrusion in an opposing direction,
the opposing direction crosses the axial direction,
the fixed end is positioned apart from the first protrusion in the opposing direction,
the second protrusion is positioned apart from the free end in the axial direction by a predetermined distance, and
the second protrusion is engaged with the first protrusion.

2. The developing cartridge according to claim 1,
wherein the housing further includes:
a toner case configured to accommodate toner, the toner case having one side surface positioned at the one side in the axial direction; and
a gear cover positioned at the one side surface of the toner case, and
wherein the first protrusion protrudes from the gear cover.

3. The developing cartridge according to claim 1,
wherein, in a state where the shaft cover is attached to the shaft,
the arm is bent; and
the portion of the arm is in contact with the first protrusion by elastic force of the arm.

4. The developing cartridge according to claim 1,
wherein the arm further has a curved portion, the curved portion being positioned between the fixed end and the second protrusion.

5. The developing cartridge according to claim 1,
wherein the shaft cover has one end surface positioned at the one side in the axial direction, and
wherein the free end is positioned further toward an other side in the axial direction than the one end surface of the shaft cover in the axial direction.

6. The developing cartridge according to claim 1,
wherein the first protrusion has one side surface positioned at the one side in the axial direction, the one side surface being sloped relative to the axial direction such that the one side surface positioned toward an other side in the axial direction as the one side surface approaches the arm.

7. The developing cartridge according to claim 1,
wherein the shaft cover is made of a first material,
wherein the first protrusion is made of a second material, and
wherein the first material having an elastic modulus that is smaller than an elastic modulus of the second material.

8. The developing cartridge according to claim 1,
wherein the housing further includes:
a base wall extending in a direction crossing the axial direction;
a holding wall protruding from the base wall toward the one side in the axial direction, the first protrusion protruding from the holding wall; and
a rib,
wherein the holding wall has:
a first surface on which the first protrusion is positioned; and
a second surface opposite the first surface, and
wherein the rib connects the base wall and the second surface to each other.

9. The developing cartridge according to claim 8,
wherein the housing further includes a boss protruding from the base wall toward the one side in the axial direction, the boss being connected to the rib, and
wherein the shaft cover further has a second hole into which the boss is fitted.
